(19) United States
(12) Patent Application Publication
(10) Pub. No.: US 2004/0188413 A1
(43) Pub. Date: Sep. 30, 2004

(54) Ceramic Susceptor and Semiconductor or Liquid-Crystal Manufacturing Apparatus in Which the Susceptor Is Installed

(75) Inventors: Masuhiro Natsuhara, Itami-shi (JP); Masaru Furusyo, Itami-shi (JP); Hirohiko Nakata, Itami-shi (JP)

Correspondence Address: JUDGE PATENT FIRM, RIVIERE SHUKUGAWA 3RD FL., 3-1 WAKAMATSU-CHO, NISHINOMIYA-SHI, HYOGO, 662-0035, JP

(73) Assignee: SUMITOMO ELECTRIC INDUSTRIES, LTD., Osaka-shi (JP)

(21) Appl. No.: 10/708,663

(22) Filed: Mar. 18, 2004

(30) Foreign Application Priority Data
Mar. 27, 2003 (JP) JP-2003-086734

(51) Int. Cl. H05B 3/68

(52) U.S. Cl. 219/444.1; 219/466.1

(57) ABSTRACT

Ceramic susceptor having a processed-object retaining face—and semiconductor as well as liquid-crystal manufacturing apparatuses in which the susceptor is installed—in which temperature uniformity in the surface of an object being processed on the susceptor is enhanced. Forming a resistive heating element in the susceptor surface on other than its processed-object retaining side, or on an internal surface of the susceptor, and forming a lead circuit for supplying electricity to the resistive heating elements in a surface separate from the surface on which the resistive heating element is formed, allows the temperature uniformity of the susceptor to be enhanced and enables uniformization of the temperature distribution in the processed-object retaining face.

### BACKGROUND OF INVENTION

1. Field of the Invention

The present invention relates to ceramic susceptors, in particular to ceramic susceptors employed in semiconductor manufacturing apparatuses or in liquid-crystal manufacturing apparatuses—such as plasma-assisted CVD, low-pressure CVD, metal CVD, dielectric-film CVD, ion-implantation, etching, low-k film heat-treatment, and degassing heat-treatment apparatuses—that demand heat uniformity, as temperature distribution, in the susceptor side in which the object being processed is retained; the invention furthermore relates to semiconductor or liquid-crystal manufacturing apparatuses in which such susceptors are installed.

2. Description of the Background Art

Conventionally, in semiconductor manufacturing procedures various processes, such as film deposition processes and etching processes, are carried out on semiconductor wafers that are the processed objects. Ceramic susceptors, which serve both to retain a semiconductor wafer and to heat the semiconductor wafer, are used in the processing apparatuses in which such processes on semiconductor wafers are carried out. Ceramic susceptors are also employed in procedures in which glass substrate for containing liquid-crystals (LCD glass) is processed, where the ceramic susceptors are used to retain and heat the LCD glass.

Japanese Unexamined Pat. App. Pub. No. H04-78138 for example discloses a conventional ceramic susceptor of this sort. The ceramic susceptor disclosed in H04-78138 includes: a heater part, made of ceramic, into which a resistive heating element is embedded and which is arranged within a chamber, wherein a wafer-heating side of the heater part is defined; a columnar support part that is provided on the side other than the wafer-heating side of the heater part, and that forms a hermetic seal between it and the chamber; and electrodes connected to the resistive heating element and leading outside the chamber so as essentially not to be exposed to the chamber interior space.

Although this invention serves to remedy the contamination and shortcomings in thermal efficiency that had been seen with the metal heaters that had gone earlier, it does not touch upon temperature distribution in semiconductor substrates being processed. Nonetheless, surface temperature distribution in semiconductor wafers and LCD glass is crucial in that it proves to be intimately related to yield in the situations where the various processes just noted are carried out.

Given the importance of temperature distribution, Japanese Unexamined Pat. App. Pub. No. H11-317283, for example, discloses a ceramic susceptor that provides for uniformizing the heating temperature of its ceramic substrate. In this invention, to design for uniformization of the ceramic-substrate heating temperature a number of resistive-heating-element circuits connected in parallel are formed in the substrate, wherein the resistive heating elements are divided into several bundles and the cross-sectional area of the resistive heating elements is premeasured and in order to uniformize the heating temperature the heating-element resistances are equalized by adjusting, to the cross-sectional area of the resistive-heating-element bundle having the smallest cross-sectional area, the cross-sectional areas of the remaining bundles.

This invention has it that the temperature distribution in the ceramic-substrate side where the semiconductor wafer is carried can be brought to within ±1.0%. Nevertheless, some of the resistive heating elements have to be severed in order to adjust the cross-sectional area of the bundles, on account of which with no current flowing to them the truncated resistive heating elements do not emit heat, resulting in the substrate temperature dropping partially.

Scaling-up of semiconductor wafers and liquid-crystal substrates has been moving forward in recent years, however. With silicon (Si) wafers for example, a transition from 8-inch to 12-inch is in progress. Likewise with LCD glass, scaling-up to an extremely large 1000 mm×1500 mm, for example, is underway. Consequent on this enlarging of semiconductor wafers and LCD glass in diametric span, that the surface temperature distribution in the semiconductor wafers and LCD glass that are the processed objects be within ±1.0% has become a necessity; that it be within ±0.5% has, moreover, come to be the expectation.

### SUMMARY OF INVENTION

The present invention has been made in order to resolve the foregoing problems. Specifically, an object of the present invention is to make available a ceramic susceptor—and semiconductor as well as liquid-crystal manufacturing apparatuses in which the susceptor is installed—in which temperature uniformity in the surface of an object being processed as loaded into the susceptor is enhanced.

A ceramic susceptor of the present invention, having a side that retains an object being processed, is characterized in that a resistive heating element is formed in the surface on other than the retaining side or on an internal surface, and in that a lead circuit for supplying electricity to the resistive heating element is formed on a surface different from the surface on which the resistive heating element is formed. The circuit pattern for the resistive heating element preferably is approximately concentric circular forms. And preferably the lead circuit three-dimensionally intersects the resistive-heating-element circuit.

The resistive-heating-element circuit pattern may be composed of a plurality of zones, with the temperature uniformity of the side that retains the processed object preferably being within ±1.0%—more preferably within ±0.5%. It is also preferable that the resistance of the lead circuit be smaller than the resistance of the resistive heating element. In addition, electrodes, connected to the lead circuit, for supplying electric power from without preferably are formed proximate to roughly the center of the ceramic susceptor.

Another preference is that the thickness of the ceramic susceptor be 5 mm or more, with the chief component of the ceramic-susceptor ceramic desirably being whichever of aluminum oxide, silicon nitride and aluminum nitride.

It is preferable, moreover, that the chief component of the ceramic be aluminum nitride, with a sintering aid added into the ceramic advantageously being an yttrium compound. And the amount of the yttrium compound added preferably is 0.01 weight % or more and 1.0 weight % or less in yttrium oxide (Y₂O₃) equivalent.

In semiconductor as well as liquid-crystal manufacturing apparatuses in which a ceramic susceptor as set forth above is installed, since surface temperature of the semi-conductor wafers or LCD glass that are the processed objects is more uniform than conventional semiconductors and liquid-crystal displays can be manufactured with better yield rates.

From the following detailed description in conjunction with the accompanying drawings, the foregoing and other objects, features, aspects and advantages of the present invention will become readily apparent to those skilled in the art.

### BRIEF DESCRIPTION OF DRAWINGS

FIG. 1 depicts one example of a pattern for a resistive-heating-element circuit in a ceramic susceptor of the present invention;

FIG. 2 depicts one example of a lead circuit connected to the resistive-heating-element circuit of FIG. 1;

FIG. 3 presents a schematic sectional view, taken along the line A-A in FIG. 1, of the ceramic susceptor in outline (partially abridged);

FIG. 4 illustrates temperature distribution in the wafer-retaining face of Embodiment 1;

FIG. 5 depicts an example of a conventional pattern for a resistive-heating-element circuit of a ceramic susceptor; and

FIG. 6 illustrates temperature distribution in the wafer-retaining face of Comparative Example 1.

### DETAILED DESCRIPTION

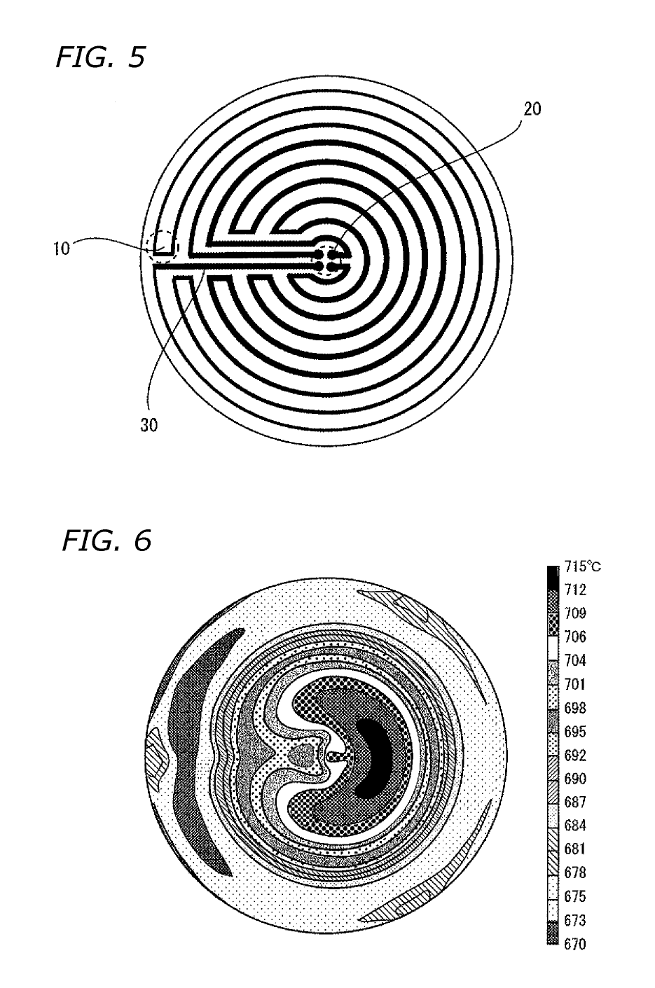

In conventional ceramic susceptors, as is the case with the foregoing Japanese Unexamined Pat. App. Pub. No. H11-317283 and as shown for example in FIG. 5, in order to dispose in the ceramic susceptor proximate to its center electrodes for supplying electricity and to form the resistive heating element in approximately concentric circular shapes, bend-back sections and lead strips for electrically connecting the resistive heating element in its outer perimeter with the electrodes are formed in the resistive-heating-element circuit pattern. The inventors discovered that owing to the difficulty of obtaining a uniform heat-emission distribution where the bend-back sections and lead strips are, the temperature uniformity of the ceramic susceptor cannot be heightened. They then arrived at the present invention thinking that consequently if the resistive-heating-element circuit were formed into approximately concentric circular shapes yet so as not to create bend-back sections or lead strips, the temperature uniformity of the ceramic susceptor could be enhanced, as could the temperature uniformity in the surface of an object being processed on the susceptor.

Specifically, the inventors discovered that in order to bring the temperature distribution in the surface of the processed object to within ±1.0%, and further, to within ±0.5%, in a ceramic susceptor having a side that retains an object being processed the resistive heating element should be formed in the surface on other than the retaining side or on an internal surface, and the lead circuit for supplying electricity to the resistive heating element should be formed on a surface different from the surface on which the resistive heating element is formed. Thus forming the resistive-heating-element circuit and the lead circuit on a plurality of separate surfaces allows the resistive-heating-element circuit pattern to be defined irrespective of the position of the electrodes connected to the lead circuit for supplying electricity from without, therefore enabling uniformization of the temperature distribution in the processed-object surface.

The resistive-heating-element circuit and the lead circuit are, for example, formed divided into two layers. The resistive-heating-element circuit pattern defined in one layer is designed so as to raise the temperature uniformity of the processed-object retaining side of the ceramic susceptor as high as possible. In doing so, conventionally the difficulty was that the resistive-heating-element circuit pattern had to be designed while taking into consideration the position of the lead circuit and of the electrodes, which would not necessarily make the most suitable circuit pattern for temperature uniformity; in the present invention, however, with the location of the lead circuit and electrodes having no relation to the pattern for the resistive-heating-element circuit, the pattern can be optimized for temperature uniformity.

The lead circuit defined in the other layer electrically connects the terminal portions of the resistive-heating-element circuit pattern with an electrode section formed proximate to the center of the ceramic susceptor. The so-called through-hole technique may be employed to connect the termini and the lead circuit electrically, by boring holes perforating the ceramic at the termini.

In order to heighten the temperature uniformity in the surface of an object being processed on the susceptor, the resistive-heating-element circuit pattern preferably is defined in approximately concentric circular shapes. The temperature along the circumferential periphery of an ordinary ceramic susceptor tends to drop because heat is radiated from the susceptor outer periphery. Consequently, the amount of heat emitted along the circumferential periphery in a resistive-heating-element circuit must be increased. Techniques easily adopted in order to increase heat emission along the periphery of the resistive-heating-element circuit if the circuit pattern is defined in roughly concentric circular shapes include making the linewidth in the pattern thinner to heighten the resistance, or narrowing the pattern spacing to raise the heat-emission density, along the periphery of the resistive heating element circuit.

What is more, because the resistive-heating-element circuit and the lead circuit are formed in separate surfaces they may be made to intersect three-dimensionally. Doing so makes it all the more possible to define the resistive-heating-element circuit pattern independent of the location of the electrodes and like components.

In addition, to make the temperature distribution in the surface of an object being processed more uniform, the pattern for the resistive-heating-element circuit may be divided into a plurality of zones, and the circuit pattern may be optimized in each zone. This is in order to make it easier to adopt measures to cope with each of the various factors that disturb the temperature uniformity of the ceramic susceptor, such as radiation of heat from the periphery, and radiation of heat from the electrodes formed in the center proximity and from support pieces, which will be described later. The plurality of zones can be two zones, a radially inner section and a radially outer section, or fours zones in which the radially inner and outer sections are each further made into two zones, or otherwise can be a left/right division or a division into a plurality of sectorial shapes.

A ceramic susceptor in which a resistive-heating-element circuit and a lead circuit as in the foregoing are formed is especially effectual when utilized in semiconductor manufacturing apparatuses and liquid-crystal manufacturing apparatuses. In semiconductor manufacturing apparatuses, because corrosive gases are employed within the chamber in which the ceramic susceptor is installed, if the electrodes are installed bare the electrodes will corrode, making it so that conduction of electricity through to the susceptor can no longer be assured and contaminating the chamber interior with the electrode material. To address this, in order to protect the electrodes a technique is employed in which shafts are joined to the susceptor and the electrodes are housed within the shafts. From a manufacturing cost perspective there preferably should be few shafts, and thus the general method is to group the electrodes in the proximity of the susceptor center and join a shaft(s) in one place onto the susceptor center portion. Given these circumstances, the techniques according to the present invention are especially advantageous for enhancing the temperature uniformity of the ceramic susceptor. The temperature uniformity in the processed-object retaining side of a ceramic susceptor by the present invention can be brought to within ±1.0%; bringing the uniformity to within ±0.5% furthermore is possible.

It is also preferable that the resistance per unit surface area of the lead circuit be smaller than the resistance per unit surface area of the resistive-heating-element circuit. A situation in which the resistance of the lead circuit is higher than the resistance of the resistive heating element is not to be preferred because the amount of heat emitted form the lead circuit would be greater than the amount of heat emitted from the resistive heating element, elevating the temperature where the lead circuit is and having an impact on the temperature uniformity. In order to lower the resistance of the lead circuit, in cases where the circuit-forming substance is the same as the substance of which the resistive heating element is made, its cross-sectional area should be made smaller than the cross-sectional area of the resistive heating element. Alternatively, a substance having a volumetric resistivity that is smaller than the volumetric resistivity of the constituent substance for the resistive-heating-element circuit may be utilized for the lead circuit. Another alternative can be to utilize such techniques as broadening the linewidth in the lead circuit, or increasing the thickness of the circuit.

In turn, a preferable condition for the thickness of a ceramic susceptor by the present invention is that it be 5 mm or more. If the thickness is less than that, heat generated by the resistive heating element does not sufficiently diffuse within the susceptor, which widens the temperature distribution in its processed-object retaining side. This condition is especially efficacious with respect to ceramic susceptors for semiconductor manufacturing apparatuses and ceramic susceptors for liquid-crystal manufacturing apparatuses, which call for temperature uniformity in the surface of the objects being processed.

There are no particular limitations on the ceramic substance constituting a ceramic susceptor of the present invention, as long as they have a high thermal conductivity and are corrosion resistant; preferably the chief component of the ceramic is whichever of aluminum oxide (alumina), silicon nitride, or aluminum nitride. As alumina (Al₂O₃) is relatively inexpensive it may be used to manufacture ceramic susceptors at low cost. Since silicon nitride (Si₃N₄) has high material strength it has excellent resistance to thermal shock; thus it is suited to use in places subject to temperature cycling and thermal shock. In turn, the high thermal conductivity of aluminum nitride (AlN) means that the temperature distribution within the ceramic is the more likely to be uniform, making it ideally suited to situations where temperature uniformity is demanded. Likewise, aluminum nitride is outstandingly corrosion-resistant against the corrosive gases employed in semiconductor manufacturing procedures, making it particularly ideal for applications in that area.

In the following, one example of a method of manufacturing a ceramic susceptor by the present invention in the case of aluminum nitride (AlN) will be described in detail.

AlN raw material powder whose specific surface area is 2.0 to 5.0 m²/g is preferable. The sinterability of the aluminum nitride declines if the specific surface area is less than 2.0 m²/g. Handling proves to be a problem if on the other hand the specific surface area is over 5.0 m²/g, because the powder coherence becomes extremely strong. Furthermore, the quantity of oxygen contained in the raw-material powder is preferably 2 wt. % or less. In sintered form, the thermal conductivity of the material deteriorates if the oxygen quantity is in excess of 2 wt. %. It is also preferable that the amount of metal impurities other than aluminum contained in the raw-material powder be 2000 ppm or less. The thermal conductivity of a sintered compact of the powder deteriorates if the amount of metal impurities exceeds this range. In particular, the content respectively of Group IV elements such as Si, and elements of the iron family, such as Fe, which as metal impurities have a serious worsening effect on the thermal conductivity of a sintered compact, is advisably 500 ppm or less.

Because AlN is not a readily sinterable material, adding a sintering aid to the AlN raw-material powder is advisable. The sintering aid added preferably is a rare-earth element compound. Since rare-earth element compounds during sintering react with aluminum oxides or aluminum oxynitrides present on the surface of the particles of the aluminum nitride powder, acting to promote densification of the aluminum nitride and to eliminate oxygen being a causative factor that worsens the thermal conductivity of the aluminum nitride sintered part, they enable the thermal conductivity of the aluminum nitride sintered part to be improved.

Yttrium compounds, whose oxygen-eliminating action is particularly pronounced, are preferable rare-earth element compounds. The amount added is preferably 0.01 to 5 wt. %. If less than 0.01 wt. %, producing ultrafine sintered materials is problematic, along with which the thermal conductivity of the sintered parts deteriorates. Added amounts in excess of 5 wt. % on the other hand lead to sintering aid being present at the grain boundaries in the aluminum nitride sintered part, and consequently, if the compact is employed under a corrosive atmosphere, the sintering aid present along the grain boundaries gets etched, becoming a source of loosened grains and particles. More preferably the amount of sintering aid added is 1 wt. % or less. Being less than 1 wt. %, the sintering aid will no longer be present even at the grain boundary triple points, which improves the corrosion resistance.

To characterize the rare-earth compounds further: oxides, nitrides, fluorides, and stearic oxide compounds may be employed. Among these, oxides, being inexpensive and readily obtainable, are preferable. By the same token, stearic oxide compounds are especially suitable since they have a high affinity for organic solvents, and if the aluminum nitride raw-material powder, sintering aid, etc. are to be mixed together in an organic solvent, the fact that the sintering aid is a stearic oxide compound will heighten the miscibility.

Next, a predetermined volume of solvent, a binder, and further, a dispersing agent or a coalescing agent as needed, are added to the aluminum nitride raw-material powder and powdered sintering aid, and the mixture is blended together. Possible mixing techniques include ball-mill mixing and mixing by ultrasound. Mixing techniques of this sort allow a raw-material slurry to be produced.

The obtained slurry is molded, and the molded product is sintered to yield a sintered aluminum-nitride part. Co-firing and metallization are two possible methods as a way of doing this.

Metallization will be described first. Granules are prepared from the slurry by spray-drying it, or by means of a similar technique. The granules are inserted into a predetermined mold and subject to press-molding. The pressing pressure therein desirably is 0.1 t/cm² or more. With pressure less than 0.1 t/cm², sufficient strength in the molded piece cannot be produced in most cases, making the piece liable to break in handling.

Although the density of the molded piece will differ depending on the amount of binder contained and on the amount of sintering aid added, the density is preferably 1.5 g/cm³ or more. A density of less than 1.5 g/cm³ would mean a relatively large distance between particles in the raw-material powder, which would hinder the progress of the sintering. At the same time, the molded product density preferably is 2.5 g/cm³ or less. Densities of more than 2.5 g/cm³ would make it difficult to eliminate sufficiently the binder from within the molded product in the degreasing process of the ensuing manufacturing procedure. It would consequently prove difficult to produce an ultrafine sintered part as described earlier.

Next, the molded product is heated within a non-oxidizing atmosphere to put it through a degreasing process. Carrying out the degreasing process under an oxidizing atmosphere such as air would degrade the thermal conductivity of the sinter, because the AlN powder would become superficially oxidized. For the non-oxidizing ambient gases, nitrogen and argon are preferable. The heating temperature in the degreasing process is preferably 500° C. or more and 1000° C. or less. With temperatures of less than 500° C., carbon is left remaining in excess within the laminate following the degreasing process because the binder cannot sufficiently be eliminated, which interferes with sintering in the subsequent sintering procedure. On the other hand, at temperatures of more than 1000° C., the amount of carbon left remaining turns out to be too little, such that the ability to eliminate oxygen from the oxidized coating superficially present on the surface of the AlN powder is compromised, degrading the thermal conductivity of the sintered part.

Another condition is that the amount of carbon left remaining within the molded product after the degreasing process is preferably 1.0 wt. % or less. Since carbon remaining in excess of 1.0 wt. % interferes with sintering, an ultrafine sintered part cannot be produced.

Next, sintering is carried out. The sintering is carried out within a non-oxidizing nitrogen, argon, or like atmosphere at a temperature of 1700 to 2000 ° C. Therein the moisture contained in the ambient gas such as nitrogen that is employed is preferably −30° C. or less given in dew point. If the atmosphere were to contain more moisture than this, the thermal conductivity of the sintered part would likely be compromised, because the AlN would react with the moisture within the ambient gas during sintering and form nitrides. Another preferable condition is that the volume of oxygen within the ambient gas be 0.001 vol. % or less. A larger volume of oxygen would lead to a likelihood that the AlN would oxidize, impairing the thermal conductivity of the sintered part.

As another condition during sintering, the jig employed is suitably a boron nitride (BN) molded part. Inasmuch as the jig as a BN molded part will be sufficiently heat resistant against the sintering temperatures, and superficially will have solid lubricity, friction between the jig and the laminate when the laminate contracts during sintering will be lessened, which will enable sinter products with little distortion to be produced.

The obtained sintered part is subjected to processing according to requirements. In cases where a conductive paste is to be screen-printed onto the sintered part in the ensuing manufacturing steps, the surface roughness is preferably 5 □m or less in Ra. If over 5 □m, in screen printing to form a circuit on the compact, defects such as blotting or pinholes in the pattern are liable to arise. More suitable is a surface roughness of 1 □m or less in Ra.

In polishing to the abovementioned surface roughness, although cases in which screen printing is done on both sides of the sintered part are a matter of course, even in cases where screen printing is effected on one side only, the polishing process should also be carried out on the surface on the side opposite the screen-printing face. This is because polishing only the screen-printing face would mean that during screen printing, the sintered part would be supported on the unpolished face, and in that situation burrs and debris would be present on the unpolished face, destabilizing the fixedness of the sintered part such that the circuit pattern might not be drawn well by the screen printing.

Furthermore, at this point the thickness uniformity (parallelism) between the processed faces is preferably 0.5 mm or less. Thickness uniformity exceeding 0.5 mm can lead to large fluctuations in the thickness of the conductive paste during screen printing. Particularly suitable is a thickness uniformity of 0.1 mm or less. Another preferable condition is that the planarity of the screen-printing face be 0.5 mm or less. If the planarity exceeds 0.5 mm, in that case too there can be large fluctuations in the thickness of the conductive paste during screen printing. Particularly suitable is a planarity of 0.1 mm or less.

Screen printing is used to spread a conductive paste and form the electrical circuits onto the sintered part having undergone the polishing process. The conductive paste can be obtained by mixing together with a metal powder an oxide powder, a binder, and a solvent according to requirements. The metal powder is preferably tungsten (W), molybdenum (Mo) or tantalum (Ta), since their thermal expansion coefficients match those of ceramics.

Adding the oxide powder to the conductive paste is also to enhance the strength with which it bonds to AlN. The oxide powder preferably is an oxide of Group ha or Group IIIa elements, or is Al₂O₃, SiO₂, or a like oxide. Yttrium oxide is especially preferable because it has very good wettability with AlN. The amount of such oxides added is preferably 0.1 to 30 wt. %. If the amount is less than 0.1 wt. %, the bonding strength between AlN and the metal layer being the circuit that has been formed is compromised. On the other hand, amounts in excess of 30 wt. % make the electrical resistance of the circuit metal layer high.

Silver-based metals such as Ag—Pd and Ag—Pt may also be utilized for the metal powder in the conductive paste. Electrical resistance of the circuits formed with the paste in that case may be controlled by adjusting the amount of palladium (Pd) or platinum (Pt) that the Ag-based metal contains. Furthermore, the same oxide powders as in the case of the tungsten or other metal powders may be added to the Ag-based metal powders. The greater the addition amount of the oxide is made, the higher the resistance will be; the lesser the addition amount is, the lower the resistance will be. Similar to that stated above, the oxide addition amount preferably is 1 wt. % or more and 30 wt. % or less.

These powders are mixed together, and by adding a binder and a solvent to the mixture a paste is prepared; predetermined circuit patterns are formed with the paste by screen printing. In doing so, the thickness of the conductive paste is preferably 5 □m or more and 100 □m or less in terms of its post-drying thickness. If the thickness is less than 5 □m the electrical resistance would be too high and the bonding strength would decline. Likewise, if in excess of 100 □m the bonding strength would be compromised in that case as well.

Also preferable is that in the patterns for the circuits that are formed, in the case of the resistive heating element circuit, the pattern spacing be 0.1 mm or more. With a spacing of less than 0.1 mm, shorting will occur when current flows in the resistive heating element and, depending on the applied voltage and the temperature, leakage current is generated. Particularly in cases where the circuit is employed at temperatures of 500° C. or more, the pattern spacing preferably should be 1 mm or more; more preferable still is that it be 3 mm or more.

After the conductive paste is degreased, baking follows. Degreasing is carried out within a non-oxidizing nitrogen, argon, or like atmosphere. The degreasing temperature is preferably 500° C. or more. At less than 500° C., elimination of the binder from the conductive paste is inadequate, leaving behind carbon in the metal layer that when baked will form metal carbides and consequently raise the electrical resistance of the metal layer.

The baking is suitably done within a non-oxidizing nitrogen, argon, or like atmosphere at a temperature, in the case of W, Mo or Ta, of 1500° C. or more. At temperatures of less than 1500° C., the post-baking electrical resistance of the metal layer turns out too high because the baking of the metal powder within the paste does not proceed to the grain growth stage. A further baking parameter is that the baking temperature should not surpass the sintering temperature of the ceramic produced. If the conductive paste is baked at a temperature beyond the sintering temperature of the ceramic, dispersive volatilization of the sintering aid incorporated within the ceramic sets in, and moreover, grain growth in the metal powder within the conductive paste is accelerated, impairing the bonding strength between the ceramic and the metal layer.

In the case of Ag-based metals on the other hand, the baking temperature preferably is 700° C. to 1000° C. The baking may be done within an air or a nitrogen atmosphere. The degreasing process described above can be omitted in processing a circuit pattern printed with an above-described Ag-based conductive paste.

Next, in order to ensure that the formed metal layer is electrically isolated, an insulative coating can be formed on the metal layer. Preferably the insulative coating substance is the same substance as the ceramic on which the metal layer is formed. Problems such as post-sintering warpage arising from the difference in thermal expansion coefficients will occur if the ceramic and insulative coating substances differ significantly. For example, in a case where the ceramic is AlN, a predetermined amount of an oxide/carbide of a Group ha element or a Group IIa element can be added to and mixed together with AlN powder, a binder and a solvent added and the mixture rendered into a paste, and the paste can be screen-printed to spread it onto the metal layer.

In that case, the amount of sintering aid added preferably is 0.01 wt. % or more. With an amount less than 0.01 wt. % the insulative coating does not densify, making it difficult to secure electrical isolation of the metal layer. It is further preferable that the amount of sintering aid not exceed 20 wt. %. Surpassing 20 wt. % leads to excess sintering aid invading the metal layer, which can end up altering the metal-layer electrical resistance. Although not particularly limited, the spreading thickness preferably is 5 □m or more. This is because securing electrical isolation proves to be problematic at less than 5 □m.

Next, in the present method, the ceramic as substrates furthermore can be laminated according to requirements. Lamination may be done via a bonding agent. The bonding agent—being a compound of Group IIa or Group IIIa elements, and a binder and solvent, added to an aluminum oxide powder or aluminum nitride powder and made into a paste—is spread onto the bonding surface by a technique such as screen printing. The thickness of the applied bonding agent is not particularly restricted, but preferably is 5 □m or more. Bonding defects such as pinholes and bonding irregularities are liable to arise in the bonding layer with thicknesses of less than 5 □m.

The ceramic substrates onto which the bonding agent has been spread are degreased within a non-oxidizing atmosphere at a temperature of 500° C. or more. The ceramic substrates are thereafter bonded to one another by stacking together the ceramic substrates to be laminated, applying a predetermined load to the stack, and heating it within a non-oxidizing atmosphere. The load preferably is 4.9 kPa (0.05 kg/cm²) or more. With loads of less than 4.9 kPa sufficient bonding strength will not be obtained, and otherwise the bonding defects just noted will be prone to occur.

Although the heating temperature for bonding is not particularly restricted as long as it is a temperature at which the ceramic substrates adequately bond to one another via the bonding layers, preferably it is 1500° C. or more. With adequate bonding strength proving difficult to gain at less than 1500° C., defects in the bond are liable to arise. Nitrogen or argon is preferably employed for the non-oxidizing atmosphere during the degreasing and bonding just discussed.

A ceramic sinter laminate that serves as a ceramic susceptor thus can be produced as in the foregoing. As far as the electrical circuits are concerned, it should be understood that if they are resistive-heating-element circuits for example, then a molybdenum coil can be utilized, and in cases such as with electrostatic-chuck electrodes and RF electrodes, molybdenum or tungsten mesh can be, without employing conductive paste.

In such cases, the molybdenum coil or the mesh can be built into the AlN raw-material powder, and the susceptor can be fabricated by hot pressing. While the temperature and atmosphere in the hot press may be on par with the AlN sintering temperature and atmosphere, the hot press desirably applies a pressure of 980 kPa (10 kg/cm²) or more. With pressure of less than 980 kPa, the ceramic susceptor might not demonstrate its performance capabilities, because interstices arise between the AlN and the molybdenum coil or the mesh.

Co-firing will now be described. The earlier-described raw-material slurry is molded into sheets by doctor blading. The sheet-molding parameters are not particularly limited, but the post-drying thickness of the sheets advisably is 3 mm or less. The sheet thickness surpassing 3 mm leads to large shrinkage in the drying slurry, raising the probability that fissures will be generated in the sheet.

A metal layer of predetermined form that serves as an electrical circuit is formed onto an abovementioned sheet using a technique such as screen printing to spread onto it a conductive paste. The conductive paste utilized can be the same as that which was descried under the metallization method. Nevertheless, not adding an oxide powder to the conductive paste does not hinder the co-firing method.

Subsequently, the sheet that has undergone circuit formation is laminated with sheets that have not. Lamination is by setting the sheets each into predetermined position to stack them together. Therein, according to requirements, a solvent is spread on between sheets. In the stacked state, the sheets are heated as may be necessary. In cases where the stack is heated, the heating temperature is preferably 150° C. or less. Heating to temperatures in excess of this greatly deforms the laminated sheets. Pressure is then applied to the stacked-together sheets to unitize them. The applied pressure is preferably within a range of from 1 to 100 MPa. At pressures less than 1 MPa, the sheets are not adequately unitized and can peel apart during subsequent manufacturing steps. Likewise, if pressure in excess of 100 MPa is applied, the extent to which the sheets deform becomes too great.

This laminate undergoes a degreasing process as well as sintering, in the same way as with the metallization method described earlier. Parameters such as the temperature in degreasing and sintering and the amount of carbon are the same as with metallization. A ceramic susceptor having a plurality of electrical circuits can be readily fabricated by printing, in the previously described screen printing of a conductive paste onto sheets, heater circuits, electrostatic-chuck electrodes, etc. respectively onto a plurality of sheets and laminating them. In this way a ceramic sinter laminate that serves as a ceramic susceptor can be produced.

The obtained ceramic sinter laminate is subject to processing according to requirements. As a rule, in the sintered state the ceramic sinter laminate usually is not within the precision demanded in semiconductor manufacturing apparatuses. The planarity of the wafer-carrying side as an example of processing precision is preferably 0.5 mm or less; moreover 0.1 mm or less is particularly preferable. The planarity surpassing 0.5 mm is apt to give rise to interstices between the ceramic susceptor and a wafer the susceptor carries, keeping the heat of the susceptor from being uniformly transmitted to the wafer and making the generation of temperature irregularities in the wafer likely.

A further preferable condition is that the surface roughness of the wafer-carrying side be 5 □m in Ra. If the roughness is over 5 □m in Ra, grains loosened from the AlN due to friction between the ceramic susceptor and the wafer can grow numerous. Grain-loosened particles in that case become contaminants that have a negative effect on processes, such as film deposition and etching, on the wafer. Furthermore, then, a surface roughness of 1 □m or less in Ra is ideal.

A ceramic susceptor base part can thus be fabricated as in the foregoing. A shaft is then attached to the ceramic susceptor. Although the shaft substance is not particularly limited as long as its thermal expansion coefficient is not appreciably different from that of the susceptor ceramic, the difference in thermal expansion coefficient between the shaft substance and the susceptor preferably is 5×10⁻⁶ K or less.

If the difference in thermal expansion coefficient exceeds 5×10⁻⁶ K, cracks can arise adjacent the joint between the ceramic susceptor and the shaft when it is being attached; but even if cracks do not arise when the two are joined, splitting and cracking can occur in the joint in that it is put through heating cycling in the course of being repeatedly used. For cases in which the wafer holder is AlN, for example, the shaft substance is optimally AlN; but silicon nitride, silicon carbide, or mullite can be used.

Another preferable condition with regard to the shaft vis-à-vis the ceramic susceptor is that the thermal conductivity of the shaft be lower than the thermal conductivity of the susceptor ceramic. Heat produced by the ceramic susceptor would be liable to escape through the shaft if the shaft thermal conductivity is higher than the ceramic thermal conductivity, which would lower the temperature of the processed-object retaining side of the susceptor directly over where the shaft is joined, degrading the surface temperature uniformity.

Mounting is joining via an adhesive layer. The adhesive layer constituents preferably are composed of AlN and Al₂O₃, as well as rare-earth oxides. These constituents are preferable because of their favorable wettability with the AlN or like ceramic that is the substance of the wafer holder and the shaft, which makes the joint strength relatively high, and readily produces a gastight joint surface.

The planarity of the respective joining faces of the shaft and ceramic susceptor to be joined preferably is 0.5 mm or less. Beyond this level interstices are liable to occur in the joining faces, impeding the production of a joint having adequate gastightness. A planarity of 0.1 mm or less is more suitable. Here, still more suitable is a planarity of the susceptor joining faces of 0.02 mm or less. Likewise, the surface roughness of the respective joining faces preferably is 5 □m or less in Ra. Surface roughness exceeding this would then also mean that interstices are liable to occur in the joining faces. A surface roughness of 1 □m or less in Ra is still more suitable.

Subsequently, electrodes are attached to the ceramic susceptor. The attaching can be done according to publicly known techniques. For example, the surface on the side of the ceramic susceptor opposite its processed-object retaining side may be spot faced through to the electrical circuit, and metallization to the circuit carried out, or without metallizing, electrodes of molybdenum, tungsten, etc. may be connected to the circuit directly using activated metal brazing material. The electrodes can thereafter be plated as needed to improve their resistance to oxidation. In this way, a ceramic susceptor can be fabricated

Moreover, semiconductor wafers can be processed on a ceramic susceptor according to the present invention, integrated into a semiconductor manufacturing apparatus. Inasmuch as the temperature of the wafer-retaining face of a ceramic susceptor by the present invention is uniform, the temperature distribution in the wafer will be more uniform than is conventional, to yield stabilized characteristics in terms of deposited films, heating processes, etc.

In addition, LCD glass can be processed on a ceramic susceptor according to the present invention, integrated into a semiconductor manufacturing apparatus. Inasmuch as the temperature of the wafer-retaining face of a ceramic susceptor by the present invention is uniform, the temperature distribution in the LCD glass surface will be more uniform than is conventional, to yield stabilized characteristics in terms of deposited films, heating processes, etc.

Embodiments

Embodiment 1-99 parts by weight aluminum nitride powder and 1 part by weight Y₂O₃ powder were mixed and blended with 10 parts by weight polyvinyl butyral as a binder and 5 parts by weight dibutyl phthalate as a solvent, and doctor-bladed into green sheets 430 mm in diameter and 1.0 mm in thickness. Here, an aluminum nitride powder having a mean particle diameter of 0.6 □m and a specific surface area of 3.4 m²/g was utilized. In addition, a tungsten paste was prepared with a tungsten powder of 2.0 □m mean particle diameter being 100 parts by weight, utilizing Y₂O³ at 1 part by weight, Al₂O₃ at 1 part by weight, 5 parts by weight ethyl cellulose, being a binder, and as a solvent, butyl Carbitol™. A pot mill and a triple-roller mill were used for mixing.

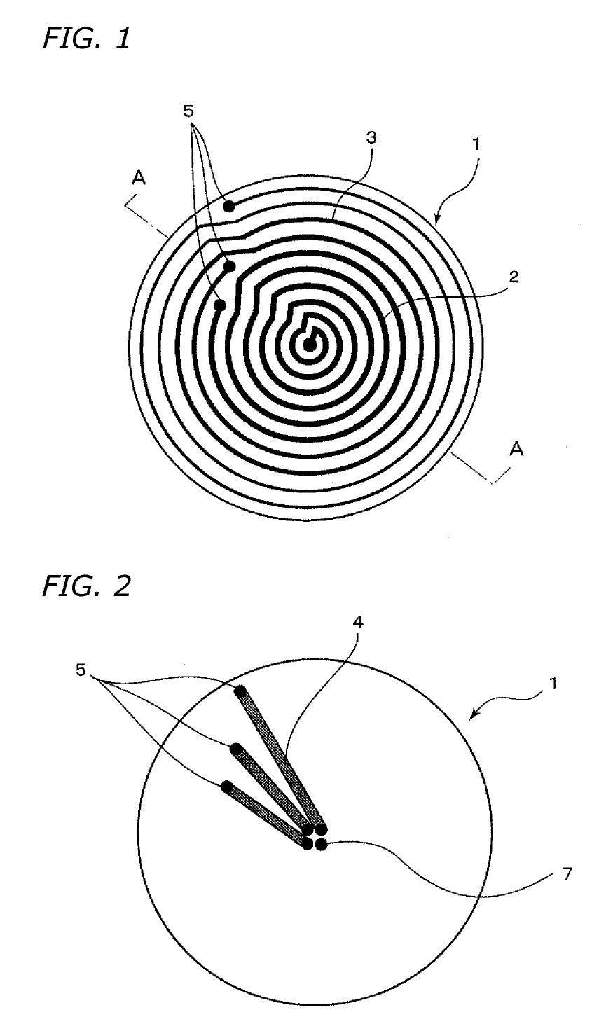

This W paste was formed into the resistive-heating-element circuit pattern shown in FIG. 1 onto the green sheets by screen-printing. Specifically, approximately concentric circular resistive heating elements 2 and 3 were patterned respectively in an area to the inside of a perimeter at 70% or less of the radius from the center, and in the area lying outside that perimeter. The linewidth of resistive heating element 2 was rendered 5 mm in the center and gradually narrowed going toward the periphery, while the linewidth of resistive heating element 3 was rendered 3 mm at the echoed periphery. The spacing between all lines was 3 mm, and the post-drying thickness was rendered 30 □m. Through-holes 6 made so as to obtain electrical connection with the lead circuit were formed at the start/end points 5 of the resistive-heating-element circuit patterns. Here, the reason the linewidth of the resistive-heating-element circuits was thus gradually narrowed approaching the periphery from the center was that since a large amount of heat is given off the ceramic along the periphery, in order to compensate for this the resistive-heating-element circuit resistance there was raised by narrowing the linewidth to increase the amount of heat emitted.

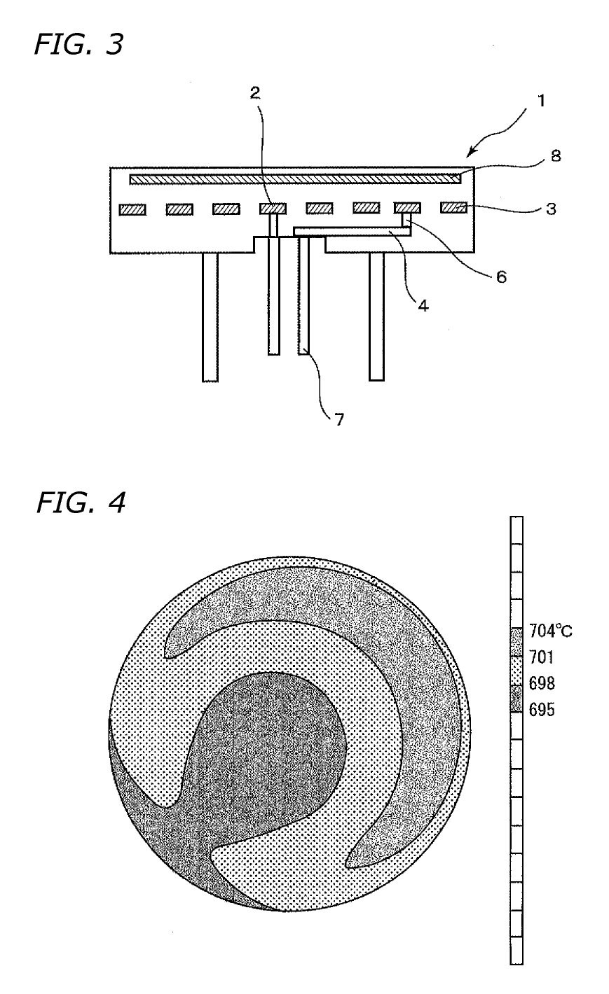

In addition, a lead circuit 4 represented in FIG. 2 was formed onto a separate green sheet. The linewidth of the lead circuit 4 was rendered 10 mm, and the post-drying thickness, 40 □m. The start/end points 5 of the resistive-heating-element circuit patterns were electrically connected to electrodes 7 as illustrated in FIG. 3 via the above-described through-holes 6 and lead circuit 4. The electrodes 7 were formed proximate to the near center of the ceramic susceptor.

A separate green sheet printed with an RF electrode circuit 8, as well as a plurality of green sheets that were not printed with anything, were laminated onto the green sheet printed with the resistive-heating-element circuit and the lead circuit, producing a laminate. Lamination was carried out by setting the sheets stacked into a mold and thermocompression bonding them in a press for 2 minutes at 10 MPa pressure while they were heated at 70° C. A ceramic susceptor unit was thereafter fabricated by carrying out degreasing within a nitrogen atmosphere at 850° C., and sintering where the conditions were 1850° C. for 3 hours within a nitrogen atmosphere, of the laminate. The dew point of the nitrogen used therein was −60° C..

After sintering, the susceptor was put through a polishing operation to bring the processed-object retaining surface to 1 □m or less in Ra, and the shaft-joint surface to 1 □m or less in Ra. The susceptor also underwent an operation to true its outer diameter. The outer diameter of the ceramic susceptor unit 1 following these operations was 330 mm; its thickness, 8 mm.

Proximate to the center on the side opposite the processed-object retaining side the susceptor surface was spot-faced through to the lead and RF electrode circuits just described, to partially expose the lead circuit and RF electrode circuit. Next an Al₂O₃—Y₂O₃—AlN based bonding agent was utilized to join to the susceptor unit a shaft made of AlN, 60 mm outside diameter, 50 mm inside diameter, and 200 mm length. Active metal brazing was utilized to bond electrodes made of Mo directly to the exposed lead circuit and RF electrode circuit. The ceramic susceptor unit was heated by passing current to the electrodes, and the susceptor temperature uniformity was measured.

For the temperature uniformity measurement, the temperature distribution in the processed-object retaining side was assayed with a thermal imager. Here the supplied electric power was adjusted so as to bring the temperature in the central portion of the processed-object retaining face to 700° C. With the temperature in the processed-object retaining face being within a range of from 697° C. to 703° C. as indicated in FIG. 4, the result was an extremely uniform ±0.43% temperature distribution.

Embodiment 2

Ceramic susceptor units having changed thicknesses as indicated in Table I were fabricated in the same manner as in Embodiment 1, and their temperature uniformity was evaluated in the same way as in Embodiment 1. The results of the evaluation are set forth in Table 1.

TABLE I

| No. | Thickness(mm) | Temperature uniformity(%) |
|---|---|---|
| 1 | 15 | ±0.32 |
| 2 | 10 | ±0.39 |
| 3 | 8 | ±0.43 |
| 4 | 6 | ±0.48 |
| 5 | 5 | ±0.50 |
| 6 | 4 | ±0.65 |
| 7 | 3 | ±0.80 |
| 8 | 2 | ±1.10 |
| 9 | 1.5 | ±1.80 |

As will be understood from Table I, the temperature disbution in the processed-object retaining side of the ceramic susceptor units could be brought to within ±1.0% by making them 3 mm or more in thickness. And by making the thickness of the ceramic susceptor units 5 mm or greater, the temperature distribution in their processed-object retaining side could be brought to within ±0.5%. It should be noted that susceptor No. 3 was the same as that of Embodiment 1.

Embodiment 3

Ceramic susceptors similar to that of Embodiment 1 were fabricated, except that the linewidth and thickness of the lead circuit were given the dimensions set forth in Table II, while the thickness of the ceramic susceptor units was made 15 mm. (The linewidth and thickness of the resistive heating element were the same as in Embodiment 1.) The temperature uniformity of each ceramic susceptor was assayed in the same way as in Embodiment 1. The results are set forth in Table II.

TABLE II

| | | | | Temperature |
|---|---|---|---|---|
| | | | Sectional area | uniformity |
| No. | Linewidth (mm) | Thickness(mm) | (mm²) | (%) |
| 10 | 10 | 0.04 | 0.4 | ±0.32 |
| 11 | 8 | 0.03 | 0.25 | ±0.41 |
| 12 | 5 | 0.03 | 0.15 | ±0.49 |
| 13 | 3 | 0.03 | 0.09 | ±0.53 |

As will be understood from Table II, the temperature uniformity of susceptor Nos. 10-12, whose lead-circuit sectional area was larger than the 0.15 mm² sectional area of the resistive heating element, was within ±0.5%, whereas the temperature uniformity of susceptor No. 13, whose lead-circuit sectional area was smaller, was outside ±0.5%, meaning that heat emission in the lead-circuit region of the susceptor was not negligible in that it compromised the temperature uniformity. It should be noted that susceptor No. 10 was the same as No. 1 of Embodiment 2.

Embodiment 4

Ceramic susceptors similar to that of Embodiment 1 were fabricated making the ceramic substances silicon nitride and alumina, respectively. The resulting temperature uniformity of the susceptors, assayed in the same manner as in Embodiment 1, was ±0.82 for the susceptor made of silicon nitride, and ±0.94 for the susceptor made of alumina. The results made it evident that the higher the thermal conductivity of the ceramic, the more the temperature uniformity improved.

Embodiment 5

Each of the ceramic susceptors of Embodiments 1 through 4 was incorporated into a semiconductor manufacturing apparatus, wherein W films were formed onto 12-inch diameter Si wafers. The result was that variability in the W film thickness was 10% or less in every one of the cases in which the ceramic susceptors were utilized, meaning that with variability in the film thickness being small excellent W films could be formed.

Embodiment

Each of the ceramic susceptors of Embodiments 1 through 4 was incorporated into a liquid-crystal manufacturing apparatus, wherein tantalum electrodes were formed on LCD glass 1000 mm×1500 mm. The result was that in every one of the cases in which the ceramic susceptors were utilized, tantalum electrodes could be formed uniformly over the entire glass substrate.

### Comparative Example 1

A ceramic susceptor was fabricated in the same manner as in Embodiment 1, except that the resistive-heating-element circuit pattern was rendered that of FIG. 5, wherein the lead circuit 30 was formed on the same side as the resistive-heating-element circuit and was joined to Mo electrodes for supplying electricity directly to the resistive-heating-element circuit. The results of assaying, in the same way as in Embodiment 1, the temperature uniformity of this ceramic susceptor are indicated in FIG. 6. As will be understood from FIG. 6, the temperature in the lead-circuit proximity fell, while opposite the lead circuit the temperature rose, leading to a temperature uniformity of some ±3% overall.

### Comparative Example 2

The ceramic susceptor of Comparative Example 1 was incorporated into a semiconductor manufacturing apparatus, wherein a W film was formed onto 12-inch diameter Si wafer. The result was that with variability in the W film thickness being more than 15%, film-thickness variability was large; thus a satisfactory W film could not be formed.

In accordance with the present invention as given in the foregoing, in a ceramic susceptor having a side that retains an object being processed, by forming a resistive heating element in the surface on other than the retaining side or on an internal surface and by forming a lead circuit for supplying electricity to the resistive heating element in a surface separate from the surface on which the resistive heating element is formed, the resistive-heating-element circuit pattern can be designed without being restricted by the location of components such as the electrodes, which affords ceramic susceptors and semiconductor as well as liquid-crystal manufacturing apparatuses that excel in temperature uniformity. If the thickness of the ceramic susceptor is made 3 mm or more, a temperature uniformity of within ±1.0% can be had; and if the thickness is made 5 mm or greater, further enhanced temperature uniformity—within ±0.5%—can be had.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A ceramic susceptor having a side for retaining an object being processed, the susceptor comprising:
a resistive-heating-element circuit formed on one surface selected from a surface on other than said retaining side, and a susceptor internal surface; and
a lead circuit for supplying electricity to the resistive heating element, formed on a surface different from the surface on which said resistive heating element is formed.

2. A susceptor as set forth in claim 1, wherein said resistive-heating-element circuit is patterned in approximately concentric circular forms.

3. A susceptor as set forth in claim 1, wherein said lead circuit three-dimensionally intersects said resistive-heating-element circuit.

4. A susceptor as set forth in claim 1, wherein said resistive-heating-element circuit is patterned in a plurality of discrete zones.

5. A susceptor as set forth in claim 1, wherein the temperature uniformity in said side for retaining an object being processed is within ±1.0%.

6. A susceptor as set forth in claim 1, wherein the resistance of said lead circuit is smaller than the resistance of said resistive-heating-element circuit.

7. A susceptor as set forth in claim 1, further comprising electrodes for supplying electric power from without, said electrodes formed proximate to roughly the center of the ceramic susceptor and connected to said lead circuit.

8. A susceptor as set forth in claim 1, wherein the susceptor thickness is 5 mm or more.

9. A susceptor as set forth in claim 1, wherein the chief component of the susceptor ceramic is one selected from aluminum oxide, silicon nitride and aluminum nitride.

10. A susceptor as set forth in claim 9, wherein the chief component of said ceramic is aluminum nitride.

11. A susceptor as set forth in claim 10, wherein an yttrium compound is added as a sintering aid into the ceramic.

12. A susceptor as set forth in claim 11, wherein the amount of the yttrium compound added is 0.01 weight % or more, and 5.0 weight % or less, in yttrium oxide (Y₂O₃) equivalent.

13. A semiconductor manufacturing apparatus in which the ceramic susceptor recited in claim 1 is installed.

14. A liquid-crystal manufacturing apparatus in which the ceramic susceptor recited in claim 1 is installed.
